(19) United States
(12) Patent Application Publication
(10) Pub. No.: US 2003/0233781 A1
(43) Pub. Date: Dec. 25, 2003

(54) Weighted fishing bait

(76) Inventor: Remo Pezzente, Etobicoke (CA)

Correspondence Address: MEREK & VOORHEES, 643-B South Washington Street, Alexandria, VA, 22314, US

(21) Appl. No.: 10/176,626

(22) Filed: Jun. 24, 2002

(51) Int. Cl. A01K 85/00

(52) U.S. Cl. 43/42

(57) ABSTRACT

A fishing bait comprising a plurality of fish eggs received within a semi-permeable casing material and a weight situated and concealed within the egg sac so as to help make the weight generally undetectable to a fish. The casing material is secured about the eggs to form an egg sac. The weight causes the egg sac to remain in contact with the bottom of a body of water when the fishing bait is received over the end of a hook secured to a fishing line and the fishing line is allowed to drift through a body of water.

### FIELD OF THE INVENTION

This invention relates to bait for general use in sport fishing, and in particular to a novel weighted bait that is especially effective when drift or float fishing.

### BACKGROUND OF THE INVENTION

Natural and artificial baits have been used by sport fishermen to catch a wide variety of different species of fish for a considerable length of time. In most instances there is a concerted effort on the part of the fisherman to utilize equipment that helps to suspend the bait off the bottom of a body of water. The suspension of the bait from the bottom of the water body has been desired to avoid snagging hooks and fishing line upon rocks, logs and other debris that may be strewn across the bottom. The desire to avoid snagging items on the bottom of a body of water is significant for all types of sport fishing but has traditionally been considered to be critical when engaging in drift or float fishing in streams or rivers.

Commonly float fishermen target salmon and trout species that inhabit rivers and streams of relatively clear water. To avoid startling game fish in clear water fishermen tend to use fishing line or leaders of a relatively thin diameter that are often of a small tensile strength. Commonly the line is attached to a float that is allowed to slowly drift with the current down the river or stream with the hope of carrying the bait past an awaiting fish. Small weights are attached to the fishing line beneath the float to help keep the bait submerged below the surface of the water. Most often the weights (often referred to as split shot) are kept back from the hook and bait a minimum of 12 to 18 inches so that the bait is allowed to float freely off the bottom and drift downstream with the current.

In many instances float fishermen utilize a number of individual artificial or natural fish eggs or roe held together in a small sacs with nylon netting through which a single barbed hook is received. Depending on the size of the fish species sought, and the form of roe that is utilized, three to five eggs are usually placed in a singe roe sac. While being slightly heavier than water the eggs and roe sac under most circumstances are buoyant enough such that the current allows the bait to drift upwardly off the bottom as the hook and line are carried downstream. Traditionally fisherman have viewed any lack of buoyancy of a roe sac as a negative attribute and have added buoyancy enhancements to ensure that the bait is suspended well off the bottom. For example, styrofoam balls, hollow glass beads filled with air, and similar items are often added to a row sac to increase its buoyancy. Others have suggested the use of elastic, rubber or latex materials that may be inflated with air and then sealed to increase the buoyancy of a row sac or bait (for example U.S. Pat. No. 4,794,720, issued to Robertaccio on Jan. 3, 1989).

While buoyant baits, including artificial and natural fish eggs, may be of value to help prevent snagging debris that may be located on the bottom of a stream or river, they effectively move the bait and the hook away from fish that may be sitting on the bottom. This movement of the bait away from bottom holding fish reduces the likelihood of a strike, particularly where fish are lethargic or not actively feeding, such as in cold water situations. Where fish are holding tight upon the bottom of a body of water, it is often the case that bait will drift by suspended in the water above them without attracting any attention whatsoever.

### SUMMARY OF THE INVENTION

The invention therefore provides a weighted fishing bait that is designed to remain in close proximity to the bottom of a body of water to help enhance the likelihood of a strike by fish holding on the bottom.

Accordingly, in one of its aspects the invention provides a fishing bait comprising; a plurality of fish eggs received within a semi-permeable casing material, said casing material sealed about said eggs to form an egg sac; and, a weight situated and concealed within said egg sacs so as to help make said weight generally undetectable to a fish, said weight causing said egg sac to remain in contact with the bottom of a body of water when said fishing bait is received over the end of a hook secured to a fishing line and the fishing line is allowed to drift through a body of water.

In a further aspect the invention provides a fishing bait for receiving over a fish hook secured to a fishing line when drift fishing in a moving body of water, said fishing bait comprising; a plurality of fish eggs received within and held together by a open weave casing material to thereby form an egg sac; and, a weight concealed within said egg sac, said weight coated with a soft pliable material that is substantially the same colour as said eggs and allowing said egg sac to maintain contact with the bottom of said moving body of water when said fishing line is permitted to drift along said moving body of water.

In another aspect the invention provides a fishing bait for receiving over the end of a hook secured to a fishing line when drift fishing in a moving body of water, said fishing bait comprising; four fish eggs arranged in a generally cubic structure and received within and held together by an open weave casing material thereby forming an egg sac; and, a weight positioned within the center portion of said cubic structure and concealed within said egg sac, said weight dimensionally smaller than said eggs and substantially the same colour as said eggs to help avoid detection of said weight by a fish in the event that fish should strike said fishing bait, said weight allowing said egg sac to maintain contact or remain in close proximity to the bottom of said moving body of water when said fishing line is permitted to drift along said moving body of water.

Further advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side elevational view of a fish hook having received over the end thereof a fishing bait in accordance with a preferred embodiment of the present invention;

FIG. 2 is a side sectional view through a body of water demonstrating the use of the fishing hook and fishing bait shown in FIG. 1;

FIG. 3 is a side elevational view of an alternate embodiment of the fishing bait shown in FIG. 1; and,

FIG. 4 is a sectional view through an alternate embodiment of a weight used in accordance with the invention shown in FIG. 1.

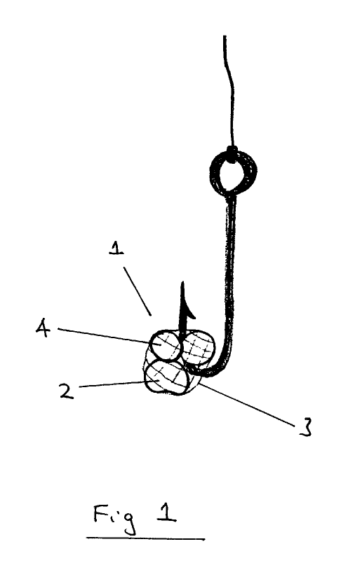

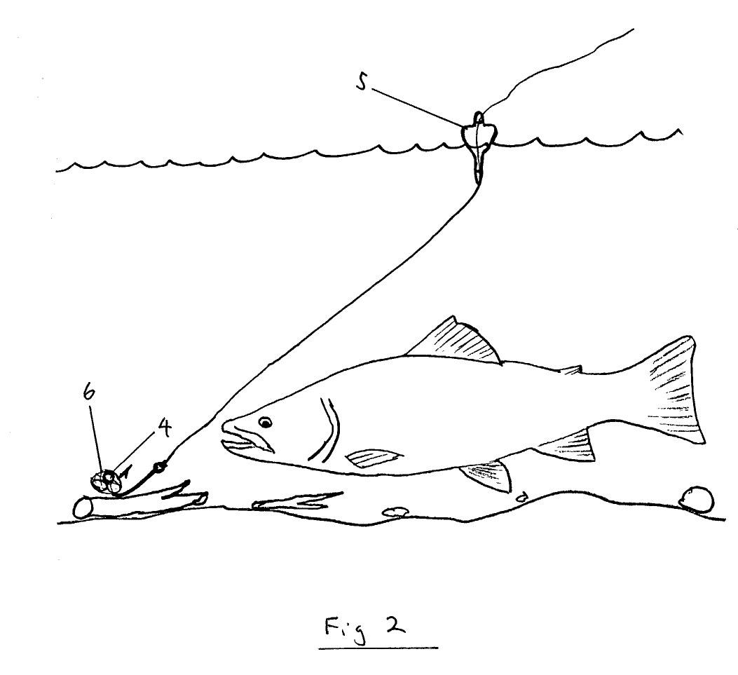

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

In the attached drawings the fishing bait according to a preferred embodiment of the present invention is noted generally by reference numeral 1. Fishing bait 1 is comprised generally of a plurality of fish eggs 2 that are received and held together by a semi-permeable casing material 3 so as to form an egg sac 6. Fish eggs 2 may be natural fish roe or, alternatively, may be artificial fish eggs made from any one of a wide variety of different compositions that have been developed to simulate the consistency, buoyancy and other characteristics of natural fish eggs. Where artificial eggs are utilized the eggs will preferably have previously been treated with a scent releasing compound and are coloured to closely match the colour of natural fish eggs. The artificial eggs will thus tend to exhibit the characteristics of natural eggs when placed within a body of water.

Casing material 3 is preferably porous or semi-permeable in order to allow for the escape of natural or artificial scent compounds when the egg sac is placed in the water. While a variety of different casing materials could be utilized, in the preferred embodiment casing material 3 is an open weave nylon material or netting, with spacing between adjacent strands sufficiently small to ensure that fish eggs 2 cannot pass therethrough. Typically casing material 3 will be formed into a bag or sleeve structure into which fish eggs 2 can be received with the end or ends of the material thereafter tied or otherwise sealed together. Casing material 3 is also preferably coloured to match the colour of fish eggs 2 in order that the egg sac closely resembles a mass of natural fish eggs floating along with the current in a body of water.

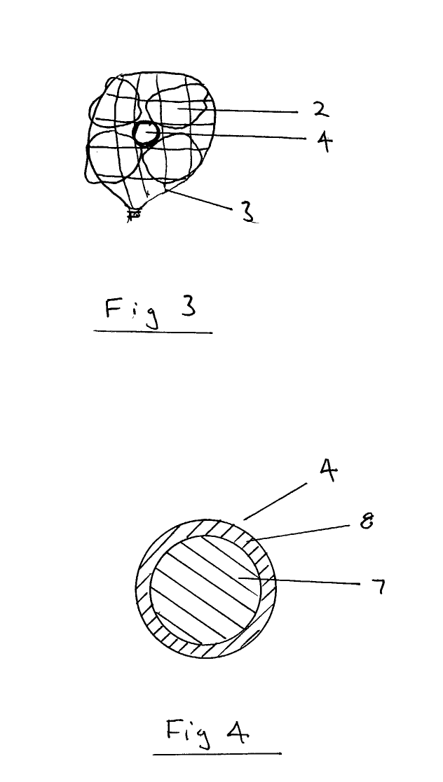

Fishing bait 1 further includes a weight 4 that is received and secured within egg sac 6 between or adjacent to fish eggs 2. Weight 4 is preferably concealed within the egg sac in an attempt to make it undetectable by a fish, either visually as the egg sac drifts along the body of water, or physically in the event of a strike by a fish. To help further aid in the concealment of weight 4 within the egg sac, weight 4 is preferably dimensioned such that it is either approximately the same size or smaller than fish eggs 2. Weight 4 is also preferably painted so that it is substantially the same colour as the eggs. In the embodiment of the invention shown in FIG. 3, four fish eggs are arranged in a generally cubic structure and held together by casing material 3. In this instance weight 4 is positioned within the center portion of the cubic structure to further conceal its presence and so that it is not readily detectable by a fish in the event that the fish should strike the egg sac.

Depending upon the particular intended application and the degree of current in a particular body of water, weight 4 may be comprised of a wide variety of high density materials, including metals, plastics, rubber or other synthetic compounds. For example, weight 4 may be made from steel, aluminum, bismuth, rubber or high density plastic. In the embodiment of the invention shown in FIG. 4, weight 4 is formed from a core 7 of a high density material that is coated with a soft pliable material 8 that provides it with a texture that mimics that of a natural or artificial fish egg. In this manner, if a fish should take bait 1 into its mouth and come into contact with weight 4 there will be less of a tendency for the fish to identify the weight concealed within the egg sac and immediately release the bait before the hook is set. Material 8 is also preferably coloured to closely match fish eggs 2 and may itself be coated with or contain fish oil or other scent releasing compounds that serve to help conceal the weight from fish and that may also act as an attractant to feeding fish.

When engaged in fishing, and in particular drift or float fishing, utilizing fishing bait 1 merely requires that a fisherman insert a fish hook through casing material 3 to secure fishing bait 1 to the end of the hook. Thereafter, as the hook and line are allowed to drift along with the current of the water weight 4, concealed within egg sac 6, will have a tendency to cause fishing bait 1 to remain in contact with the bottom of the body of water. In instances where a float or bobber 5 is utilized and the length of line beneath the float is less than the depth of water, weight 4 will cause fishing bait 1 and the hook to which it is attached to be suspended a desired distance from the bottom of the body of water. In either case, the utilization of weight 4 and its concealment within the egg sac helps prevent the fishing bait and hook from drifting upwardly toward the surface and away from the bottom, particularly in rivers or streams that have a significant current. In this fashion the bait and fishing hook are maintained closer to fish that may be holding next to the bottom or adjacent to underwater structure. The utilization of a concealed weight within the egg sac further helps to eliminate the need for the fisherman to attach one or a series of small weights to the fishing line below the float or bobber to help maintain the bait in close proximity to the bottom. Through eliminating the need for the use of a series of small weights, fish are less likely to be startled by the fishing line as it drifts past them, particularly in clear water situations.

It is to be understood that what has been described are the preferred embodiments of the invention and that it may be possible to make variations to these embodiments while staying within the broad scope of the invention. Some of these variations have been discussed while others will be readily apparent to those skilled in the art.

I claim:

1. A fishing bait comprising:
(i) a plurality of fish eggs received within a semi-permeable casing material, said casing material secured about said eggs to form an egg sac; and,
(ii) a weight situated and concealed within said egg sac so as to help make said weight generally undetectable to a fish, said weight causing said egg sac to remain in contact with the bottom of a body of water when said fishing bait is received over the end of a hook secured to a fishing line and the fishing line is allowed to drift through a body of water.

2. The device as claimed in claim 1 wherein said weight is dimensionally the same or smaller than said fish eggs to thereby help assist in the concealment of said weight within said egg sac.

3. The device as claimed in claim 2 wherein said weight is substantially the same colour as said fish eggs.

4. The device as claimed in claim 3 wherein said casing material is comprised of an open weave nylon material.

5. The device as claimed in claim 4 wherein said fish eggs are real or artificial fish eggs.

6. The device as claimed in claim 1 including four fish eggs arranged in a generally cubic structure, said weight positioned within the center portion of said cubic structure to help avoid detection of said weight by a fish in the event that said fish should strike said fishing bait.

7. The device as claimed in claim 6 wherein said weight is formed from a core of a high density material and an outer coating comprised of a soft pliable material, said soft pliable material coloured to closely match the colour of said fish eggs.

8. The device as claimed in claim 7 wherein said soft pliable coating on said weight includes fish oil or a scent releasing compound.

9. The device as claimed in claim 1 wherein said weight is formed from a core of a high density material and an outer coating comprised of a soft pliable material, said soft pliable material coloured to closely match the colour of said fish eggs.

10. The device as claimed in claim 9 wherein said soft pliable coating on said weight includes fish oil or a scent releasing compound.

11. A fishing bait for receiving over a fish hook secured to a fishing line when drift fishing in a moving body of water, said fishing bait comprising:
(i) a plurality of fish eggs received within and held together by a open weave casing material to thereby form an egg sac; and,
(ii) a weight concealed within said egg sac, said weight coated with a soft pliable material that is substantially the same colour as said eggs and allowing said egg sac to maintain contact with the bottom of said moving body of water when said fishing line is permitted to drift along said moving body of water.

12. The device as claimed in claim 11 wherein said weight is dimensionally smaller than said fish eggs to assist in the concealment of said weight within said egg sac.

13. The device as claimed in claim 12 wherein said soft pliable coating on said weight includes fish oil or a scent releasing compound.

14. A fishing bait for receiving over the end of a hook secured to a fishing line when drift fishing in a moving body of water, said fishing bait comprising:
(i) four fish eggs arranged in a generally cubic structure and received within and held together by an open weave casing material thereby forming an egg sac; and,
(ii) a weight positioned within the center portion of said cubic structure and concealed within said egg sac, said weight dimensionally smaller than said eggs and substantially the same colour as said eggs to help avoid detection of said weight by a fish in the event that fish should strike said fishing bait, said weight allowing said egg sac to maintain contact or remain in close proximity to the bottom of said moving body of water when said fishing line is permitted to drift along said moving body of water.

15. The device as claimed in claim 14 wherein said weight is formed from a core of a high density material and an outer coating comprised of a soft pliable material.

16. The device as claimed in claim 15 wherein said soft pliable coating on said weight includes fish oil or a scent releasing compound.
